(19) United States
(12) Patent Application Publication
(10) Pub. No.: US 2025/0362749 A1
(43) Pub. Date: Nov. 27, 2025

(54) USER-CUSTOMIZED LANGUAGE DERIVATION METHOD AND DEVICE BASED ON BRAINWAVE

(71) Applicant: SEOUL NATIONAL UNIVERSITY R&DB FOUNDATION, Seoul (KR)

(72) Inventors: Chun Kee CHUNG, Seoul (KR); Jii KWON, Seoul (KR); Ye Jin PARK, Seoul (KR); Gyuwon LEE, Seoul (KR)

(21) Appl. No.: 19/188,098

(22) Filed: Apr. 24, 2025

(30) Foreign Application Priority Data
May 27, 2024 (KR) 10-2024-0068544

(51) Int. Cl. G06F 3/01; G10L 15/02; G10L 15/183; G10L 25/75

(52) U.S. Cl. CPC G06F 3/015; G10L 15/02; G10L 15/183; G10L 25/75; G10L 2015/027

(57) ABSTRACT

A user-customized language derivation method based on brainwaves includes deriving utterance intent by analyzing brainwaves of a user, and deriving an intended language of the user based on the utterance intent and a preset user-customized vocabulary, and deriving a user-customized language by inputting the intended language and situation information of the user to a preset large language model, wherein the large language model is pre-trained to output the user-customized language by considering the user-customized vocabulary and the situation information of the user.

### CROSS-REFERENCE TO RELATED APPLICATION

This application is based on and claims priority under 35 U.S.C. § 119 to Korean Patent Application No. 10-2024-0068544, filed on May 27, 2024, in the Korean Intellectual Property Office, the disclosure of which is incorporated by reference herein in its entirety.

### BACKGROUND

### 1. Field

The present disclosure relates to a user-customized language derivation method and device based on brainwaves, and more specifically, to a technology for deriving a user-customized language by considering a language predicted based on a user's brainwaves, a user's vocabulary, and surrounding circumstances.

### 2. Description of the Related Art

In the existing related studies, a technology has been proposed to find out which letters a user is looking at from brainwaves while continuously looking at specific letters in a manner such as steady state visually evoked potential (SSVEP), and to predict the language intended by a user by combining letters.

However, this approach has a major disadvantage in that a user requires staring at letters for a specific period of time and requires prediction for each letter, which takes a long time to produce the final word.

Also, a method for recognizing conversational intent has been studied in which a user is provided with sounds of N example words, brainwaves corresponding to utterance imagination, actions, and so on are measured, and when the user has a utterance intent, a model that learns brainwave characteristics for each word is used to find and output similar words from the learned model.

However, there is a problem that the number of words previously learned may be restrictive and it is difficult to expand to similar words according to the context or a user's characteristics.

Accordingly, research is needed on technology that enables personalized real-time situation-based communication through correction to a more appropriate language according to a user's current situation or context, the user's education, and a vocabulary level.

The related art includes Korea Patent No. 10-2175997 (Title of the invention: METHODS AND APPARATUSES FOR RECOGNIZING USER INTENTION BASED ON BRAINWAVE, Application date: Dec. 13, 2018).

### SUMMARY

The present disclosure provides a method and device for deriving a user-customized language by considering the language predicted based on a user's brainwaves, the user's vocabulary, and a surrounding situation.

Technical problems to be solved by the present disclosure are not limited to the technical problems described above, and other technical problems of the present disclosure may be derived from following descriptions.

According to a first aspect of the present disclosure, a user-customized language derivation method based on brainwaves is provided. The user-customized language derivation method based on brainwaves includes deriving utterance intent by analyzing brainwaves of a user, and deriving an intended language of the user based on the utterance intent and a preset user-customized vocabulary, and deriving a user-customized language by inputting the intended language and situation information of the user to a preset large language model, wherein the large language model is pre-trained to output the user-customized language by considering the user-customized vocabulary and the situation information of the user.

According to a second aspect of the present disclosure, a user-customized language derivation device based on brainwaves is provided. The user-customized language derivation device includes a communication module communicably connected to a terminal, a processor, and a memory electrically connected to the processor and storing at least one code configured to be executed by the processor, wherein, when the memory is operated by the processor, the processor derives utterance intent by analyzing brainwaves of a user, derives an intended language of the user based on the utterance intent and a preset user-customized vocabulary, and derives a user-customized language by inputting the intended language and situation information of the user to a preset large language model, and the large language model is pre-trained to output the user-customized language by considering the user-customized vocabulary and the situation information of the user.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a user-customized language derivation device according to an embodiment of the present disclosure and a terminal communicably connected to the device;

FIG. 2 is a diagram illustrating a detailed configuration of the user-customized language derivation device illustrated in FIG. 1;

FIG. 3 illustrates diagrams of examples of brainwaves;

FIG. 4 is a view illustrating statistical significance for each frequency and time according to the number of syllables;

FIG. 5 illustrates views of brain regions for encoding the number of syllables;

FIGS. 6A-6D illustrate views for distinguishing between a body and a non-body in predicting meaning;

FIG. 7 is a flowchart illustrating a sequence of a user-customized language derivation method, according to another embodiment of the present disclosure;

FIGS. 8 and 9 are flowcharts illustrating details of some operations of the user-customized language derivation method according to another embodiment of the present disclosure; and

FIG. 10 is a drawing illustrating an example of a user-customized language derivation method according to another embodiment of the present disclosure.

### DETAILED DESCRIPTION

Hereafter, the present disclosure will be described in detail with reference to the accompanying drawings. However, the present disclosure may be implemented in many different forms and is not limited to the embodiments described herein. Also, the accompanying drawings are only for easy understanding of the embodiments disclosed in the present specification, and the technical ideas disclosed in the present specification are not limited by the accompanying drawings. All terms, which include technical and scientific terms used herein, should be interpreted as having the meaning generally understood by a person of ordinary skill in the art to which the present disclosure belongs. Terms defined in advance should be interpreted as having additional meanings consistent with the relevant technical literature and the present disclosure, and should not be interpreted in a very ideal or restrictive sense unless otherwise defined.

In order to clearly describe the present disclosure in the drawings, parts irrelevant to the descriptions are omitted, and a size, a shape, and a form of each component illustrated in the drawings may be variously modified. The same or similar reference numerals are assigned to the same or similar portions throughout the specification.

Suffixes “module” and “unit” for the components used in the following description are given or used interchangeably in consideration of ease of writing the specification, and do not have meanings or roles that are distinguished from each other by themselves. Also, in describing the embodiments disclosed in the present specification, when it is determined that a detailed descriptions of related known technologies may obscure the gist of the embodiments disclosed in the present specification, the detailed descriptions are omitted.

Throughout the specification, when a portion is said to be “connected (coupled, in contact with, or combined)” with another portion, this includes not only a case where it is “directly connected (coupled, in contact with, or combined)” “, but also a case where there is another member therebetween. Also, when a portion “includes (comprises or provides)” a certain component, this does not exclude other components, and means to “include (comprise or provide)” other components unless otherwise described.

Terms indicating ordinal numbers, such as first and second, used in the present specification are used only for the purpose of distinguishing one component from another component and do not limit the order or relationship of the components. For example, the first component of the present disclosure may be referred to as the second component, and similarly, the second element may also be referred to as the first component. Singular forms used herein should be construed to include plural forms, unless the opposite is clearly indicated.

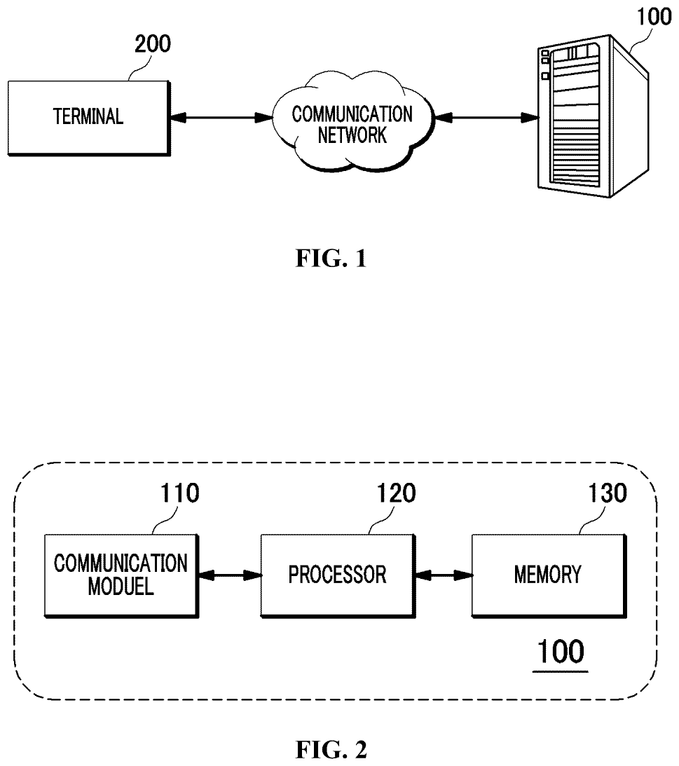

FIG. 1 is a diagram illustrating a user-customized language derivation device according to an embodiment of the present disclosure and a terminal communicably connected to the user-customized language derivation device.

Referring to FIG. 1, a user-customized language derivation device 100 may be communicably connected to a terminal 200 through a preset communication network to transmit and receive information.

The user-customized language derivation device 100 may generate a user-customized vocabulary by replacing an audio signal of a user with a text signal.

The user-customized language derivation device 100 analyzes a user's brainwaves to derive utterance intent and an intended language of the user based on the utterance intent and a preset user-customized vocabulary. Here, the utterance intent may include voice intent, phonetic intent, and semantic intent.

The voice intent may be extracted through brainwaves according to motions of vocal cords. A pitch of a formant may change according to the motions of the vocal cords.

Therefore, the user-customized language derivation device 100 may determine the formant by predicting the motion of the vocal cords including container 1 and container 2 through brainwaves.

Also, the user-customized language derivation device 100 may apply a technique of fitting a spectrum of the formant from a frequency pattern of brainwaves over time, such as high gamma, by using deep learning.

The user-customized language derivation device 100 inputs the intended language and a user's situation information to a preset large language model to derive a user-customized language. Here, a large language model may be pre-trained to output a user-customized language by considering a user-customized vocabulary and the user's situation information.

The user-customized language derivation device 100 may transmit the user-customized language to a terminal communicably connected thereto, receive feedback information on the user-customized language, and update a decoder for extracting a brainwave-based language according to the feedback information.

The user-customized language derivation device 100 may be implemented with a server, a computing device, or various smart devices, and may operate in a cloud computing service model, such as software as a service (SaaS), platform as a service (PaaS), or infrastructure as a service (IaaS). Also, the user-customized language derivation device 100 may be implemented with a private cloud, a public cloud, or a hybrid cloud system, but the scope of the present disclosure is not limited thereto.

The terminal 200 may transmit a user's audio signal and brainwaves to the user-customized language derivation device 100. Here, the terminal 200 may store brainwaves measured through a brainwave measuring device (not illustrated), but is not limited thereto, and the brainwaves may be transmitted to the user-customized language derivation device 100 in real time through a brainwave measuring device (not illustrated) communicably connected to the user-customized language derivation device 100.

Also, the terminal 200 may receive a user-customized language from the user-customized language derivation device 100.

The terminal 200 may include a desktop computer or a laptop computer equipped with a web browser, a wireless communication device or a smart phone with portability and mobility, or any type of handheld-based wireless communication device such as tablet personal computer (PC).

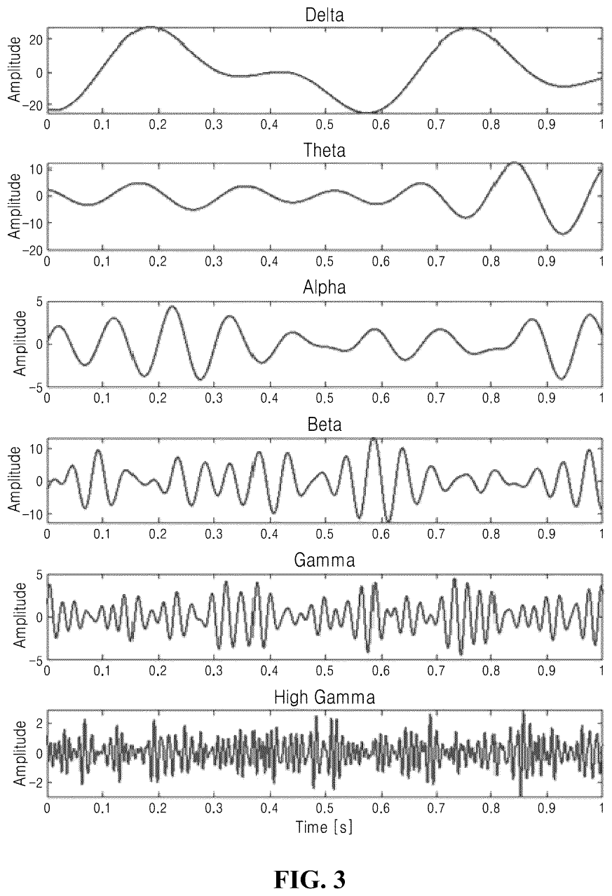

FIG. 2 is a diagram illustrating a detailed configuration of the user-customized language derivation device illustrated in FIG. 1.

Referring to FIG. 2, the user-customized language derivation device 100 may include a communication module 110, a processor 120, and a memory 130.

The communication module 110 may include a device including hardware and software required for transmitting and receiving signals, such as control signals or data signals through wired or wireless connections with another network device.

The communication module 110 may receive a user's audio signal from a terminal and provide a user-customized language to the terminal.

The processor 120 may include various types of devices that control and process data. The processor 120 may indicate a data processing device built in hardware including a physically structured circuit to perform a function indicated by code or commands included in a program.

In one example, the processor 120 may be implemented with a microprocessor, a central processing unit (CPU), a processor core, a multiprocessor, an application-specific integrated circuit (ASIC), a field programmable gate array (FPGA), or so on, but the scope of the present disclosure is not limited thereto.

The processor 120 performs operations according to code stored in the memory 130.

The memory 130 may store at least one of information and data input to the communication module 110, information and data required for functions performed by the processor 120, and data generated according to execution of the processor 120.

The memory 130 should be interpreted as a general term for a nonvolatile storage device that maintains stored information even when power is not supplied and a volatile storage device that requires power to maintain the stored information. The memory 130 may include a cloud storage, a solid state drive (SSD), magnetic storage media, or flash storage media in addition to volatile storage devices that require power to maintain the stored information, but the scope of the present disclosure is not limited thereto.

The memory 130 is electrically connected to the processor 120 and stores at least one code that is executed by the processor 120. The memory 130 stores code that causes the processor 120 to perform following functions and procedures when executed by the processor 120.

The memory 130 may store code that causes a user's audio signal to be replaced with a text signal to generate a user-customized vocabulary. For example, the memory 130 may store code that causes an audio signal including a user's daily conversation recorded for a certain period of time to be received from a terminal.

The memory 130 may store code that causes an audio signal to be replaced with a text signal by using a model, such as a speech-to-text technique, and causes a user-customized vocabulary to be generated based on the frequency of uttered words of a user. For example, the memory 130 may store code that causes a user to generate a user-customized vocabulary based on which words the user mainly uses.

Here, the user-customized vocabulary may be applied to a brainwave-based decoder and a preset language model to reduce the number of cases of predicted words such that the language thought by a user may be more accurately answered.

The memory 130 may store code that causes a user's brainwaves to be analyzed to derive utterance intent and derive the user's intended language based on the utterance intent and the preset customized vocabulary. For example, based on the code stored in the memory 130, a group of word candidates that a user wants to utter and the probability of utterance for each candidate may be extracted from a user's brainwaves.

The memory 130 may store code that causes voice intent, phonetic intent, and semantic intent to be derived.

The memory 130 may store code that causes derivation of vocal intent for predicting at least one of a position and a size of a formant expressed from motion of vocal cords based on brainwaves.

The memory 130 may store code that causes analysis of brainwaves in a time series by using at least one of an LSTM, a transformer, and a GRU model or causes analysis of brainwaves in a time series by using a classification model (SVM, LDA, and so on) that quantizes a formant into specific bins and then predicts the probability of entering the bin.

The memory 130 may store code that causes extraction of a phonetic intent for predicting at least one of the number of consonants, vowels, and syllables to be uttered based on voice intent and brainwaves. For example, brainwaves for extracting phonetic intent may be brainwaves of a temporal pole of the brain for processing the corresponding information in a relevant region, such as the temporal pole of the brain.

For example, the memory 130 may store code that causes classification to be performed by a model, such as a long short-term memory (LSTM) or a transformer, or a model, such as a support vector machine (SVM) or a K-Nearest Neighbor (K-NN).

Here, phonemes and voice may have a hierarchy, such as prosodemes, syllables, and phrases. Accordingly, the memory 130 may store code that causes brain signals to be extracted by adjusting a length of a time window of a brainwave to be used for prediction according to a hierarchical unit.

The memory 130 may store code that causes the extracted voice intent to be used as a previous probability to determine phonetic intent. For example, the memory 130 may store code that causes positions of F1 and F2 of a formant predicted from the brainwaves to be converted into two dimensions to determine the probability of each vowel and the probability of consonant or vowel.

The memory 130 may store code that causes the meaning of a language to be uttered to be extracted, based on the brainwaves, in at least one form from among a category, an embedding vector, and a form in which the category is combined with the embedding vector to extract semantic intent. Here, the category may be at least one of a living body, a nonliving body, and a building.

The memory 130 may store code that causes the meaning of language to be predicted in at least one form from among a form of category and a form of embedding vector based on brainwaves.

The memory 130 may store code that causes vectors for each word to be extracted for specific words in the category.

The memory 130 may store code that causes words according to the semantic intent to be extracted by comparing spatial similarity between a word vector and an embedding vector.

For example, the memory 130 may store code that causes words according to semantic intent through spatial similarity comparison with embedding vectors predicted from brainwaves to be extracted by predicting a specific category and an embedding vector in parallel from brain waves and then re-obtaining vectors for each word from a word embedding model, such as Word2Vec or GloVe for specific words within a corresponding category.

The memory 130 may store code that causes selection of an intended language of which similarity with utterance intent is greater than or equal to a preset value among words included in a user-customized vocabulary.

The memory 130 may store code that causes comparison of similarity between word lists according to semantic intent and predicted phonetic information according to voice intent and phonetic intent.

The memory 130 may store code that causes selection of an intended language based on similarity but causes selection of the intended language from among words corresponding to a user-customized vocabulary by using a preset decoder.

For example, the memory 130 may store code that causes determination, as an intended language, a word with the highest degree of consistency with predicted phonetic information on an utterance language, such as a structure of consonant and vowel or the number of syllables, from voice intent and phonetic intent among word lists of a category or a vector with semantic intent by using a brainwave-based decoder. Here, the memory 130 may store code that causes the brainwave-based decoder to select words to be predicted by reducing the number of possible cases to words in a user's vocabulary in order to increase prediction accuracy.

The memory 130 may store code that causes a user-customized language to be derived by inputting an intended language and a user's situation information to a preset large language model.

The memory 130 may store code that causes a user-customized vocabulary to be set from a user's education, environment, and frequently encountered or used words and causes a large language model to be trained to a model optimized for a user based on the set vocabulary. Here, the large language model is pre-trained to output a user-customized language considering a user-customized vocabulary and a user's situation information and may be one of a generative pre-trained transformer (GPT) and Llama.

The memory 130 may store code that causes a user's real-time situation information to be received. For example, the memory 130 may store code that causes the receiving of real-time situational information collected from a device, which may measure an external environment, such as a microphone, a camera, and so on.

The memory 130 may store code that causes a user's environment (for example, whether there is a public place) and so on to be analyzed by obtaining a vocabulary level of a user's conversation partner. For example, the vocabulary level and the user's environment may be analyzed by at least one of a speech-to-text technology, SNN for image analysis, object detection using YOLO (you only look once) and faster R-CNN for purposes such as classifying people wearing suits or recognizing conference tables, and a scene recognition technique.

The memory 130 may store code that causes a large language model to be trained to output a user-customized language to which a vocabulary level and speech style is applied according to a user-customized vocabulary and a user's situation information, by considering the user-customized vocabulary and the user's situation information. Here, the large language model may be a large language model (LLM).

Here, the real-time situation information may include at least one of a surrounding voice signal, image data for a space to which a user belongs, and global positioning system (GPS)-based position data.

The memory 130 may store code that causes an LLM to be trained to generate an output value with a tone similar to a corresponding sentence by converting a voice signal into a text from a surrounding voice signal of a user by using a speech-to-text technique.

The memory 130 may store code that causes clothing, number of people, arrangement of objects, human behavior, and so on to be extracted through a method, such as object detection or key point detection. Also, the memory 130 may store code that causes an LLM to be trained to classify whether a current position of a user is a public or private place based on data previously labeled as public and private places.

The memory 130 may store Code that causes a user-optimized language model based on a real-time situation to be generated and updated to extract a vocabulary level and speech style appropriate to a user's current situation by adding predicted situation information to an LLM.

The memory 130 may store code that causes a user-customized language corresponding to an intended language to be extracted by considering a user's situation information through an LLM.

For example, the memory 130 may store code that ultimately causes an appropriate language to be selected and output by using the trained user-optimized language model based on a real-time situation for the intended language predicted from brainwaves.

For example, when an intended language is “I am hungry” and a partner uses a polite language to a user, the memory 130 may store code that causes “I am hungry” to be finally converted into a polite language through a language model by using a preceding sentence or so on. When the partner says “Let's go to eat now” in the previous sentence, a final phrase “All

right, it's time to eat” may be output, and when the partner uses a polite language and the previous sentence is not related to eating, a final phrase “I am sorry, would you mind taking a moment to eat?” may be derived.

Meanwhile, when a user is at home and has a friendly conversation with the partner, a final phrase “I am hungry, and let's eat now” may be derived.

The memory 130 may store code that causes a decoder to be updated which transmits a user-customized language to a terminal communicably connected to the decoder, receives feedback information on the user-customized language, and derives a brainwave-based language from the feedback information.

For example, the feedback may be an indicator, such as a match or a mismatch, or an indicator of similarity, such as a percentage. The memory 130 may store code that causes a brainwave-based decoder to be trained by determining that there is an error when the similarity is less than or equal to a preset value and transmitting the error to the brainwave-based decoder.

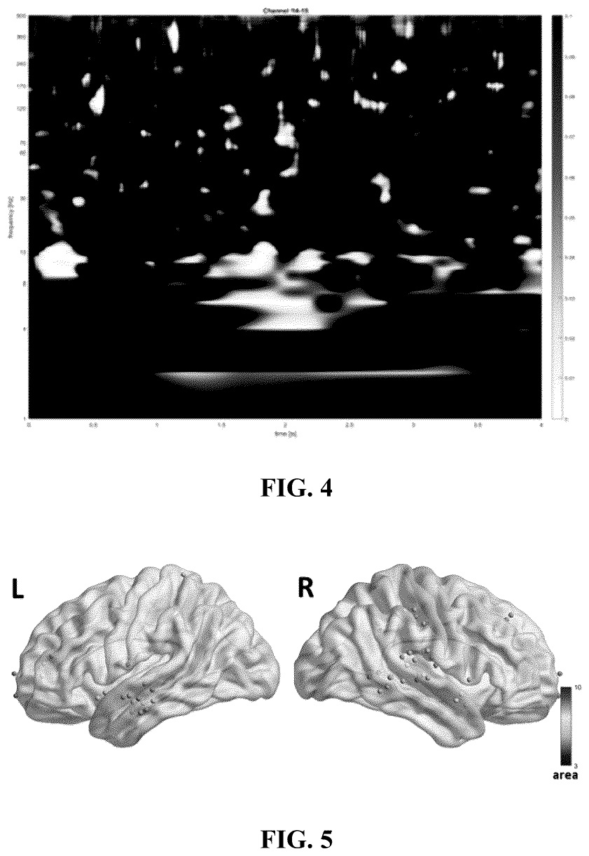

FIG. 3 illustrates diagrams of examples of brainwaves.

Referring to FIG. 3, the user-customized language derivation device 100 may extract at least one of an event-related potential (ERP), spectral power, and a frequency-specific amplitude through fast Fourier transform (FFT) from brainwaves and analyze the extracted element to select an intended language. Here, the brainwave may be at least one of electrocorticogram (ECoG), electroencephalography (EEG), and magnetoencephalography (MEG).

The user-customized language derivation device 100 may adjust a length of a time window to extract at least one of an ERP, spectral power, and a frequency-specific amplitude through FFT, which are characteristics of a brainwave. Here, the time window may include information on a time axis size of the brainwave used to calculate characteristics of the brainwave.

For example, when word-by-word decoding is performed, one word may correspond to 0.12 seconds as the number of words per minute is 500 words on average when a person thinks. Therefore, when the word-by-word decoding is performed, a brainwave of 0.12 seconds may be used.

In another example, when sentence-by-sentence decoding is performed based on a sentence consisting of 17 words, a brainwave may be used for about 2 seconds which is obtained by 0.12 s*17.

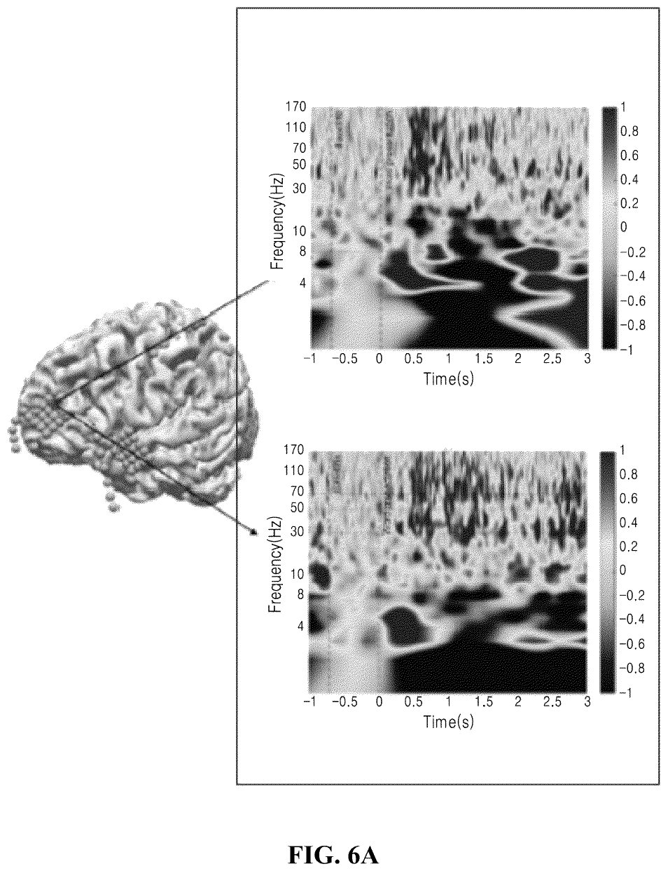

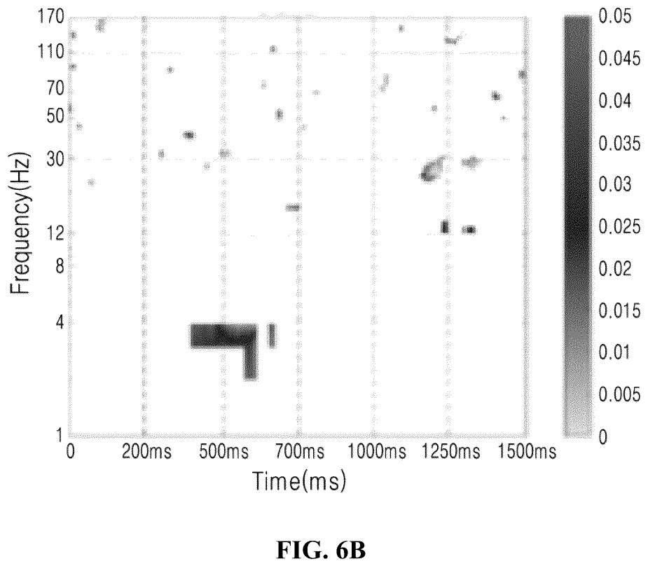

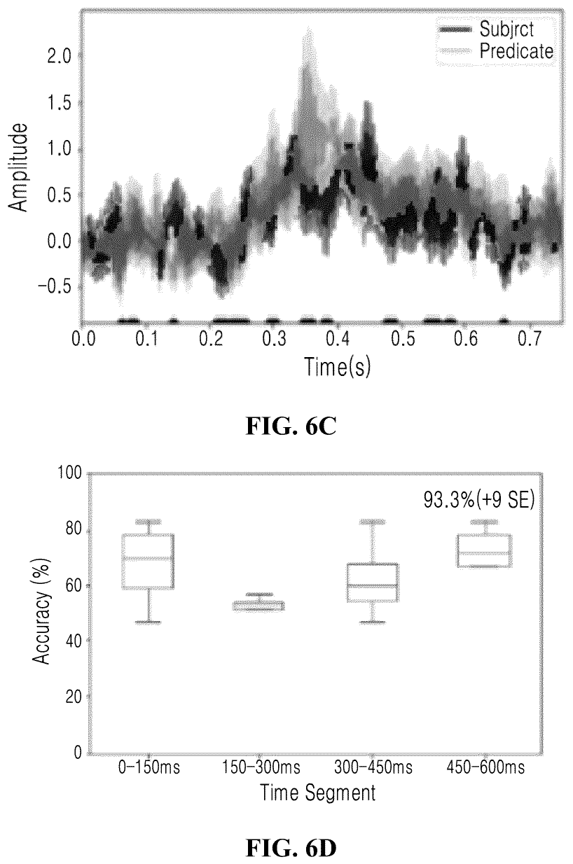

FIG. 4 is a view illustrating statistical significance for each frequency and time according to the number of syllables, FIG. 5 illustrates views of brain regions for encoding the number of syllables, and FIGS. 6A-6D illustrate views for distinguishing between a body and a non-body in predicting meaning.

Referring to FIG. 4, a frequency for each time according to the number of syllables may be seen. An x-axis may denote time, and a y-axis may denote a frequency.

The greater the degree of change according to the number of syllables, the darker the color may be displayed. In other words, the smaller the p-value, the darker the color may be displayed.

Referring to FIG. 5, top 10% of electrodes of which brainwaves change greatly according to the number of syllables are displayed on the brain. In this case, a difference in brainwave according to the number of syllables may be obtained by using regions of dissimilarity obtained by a statistical method.

Referring to FIG. 6, FIG. 6A is a view illustrating a result of continuous wavelet transform in a specific brain region, FIG. 6B and FIG. 6C are examples of frequencies and time in which there is a significant difference (p<0.05) between semantic categories, and FIG. 6D is a view illustrating a result of predicting language meaning by using only features on a region, a frequency, and time in which there are significant differences. Here, an upper view of FIG. 6A may illustrate a part of a body, and a lower view of FIG. 6A may illustrate a part of a non-body.

In a frequency range and time window used to derive the results, theta may be 4 to 8 Hz and 250 ms, alpha may be 8 to 12 Hz and 200 ms, beta may be 12 to 30 Hz and 200 ms, gamma may be 30 to 50 Hz and 150 ms, high-gamma 1 (HG 1) may be 70 to 110 Hz and 150 ms, and high-gamma 2 may be 110 to 170 Hz and 150 ms.

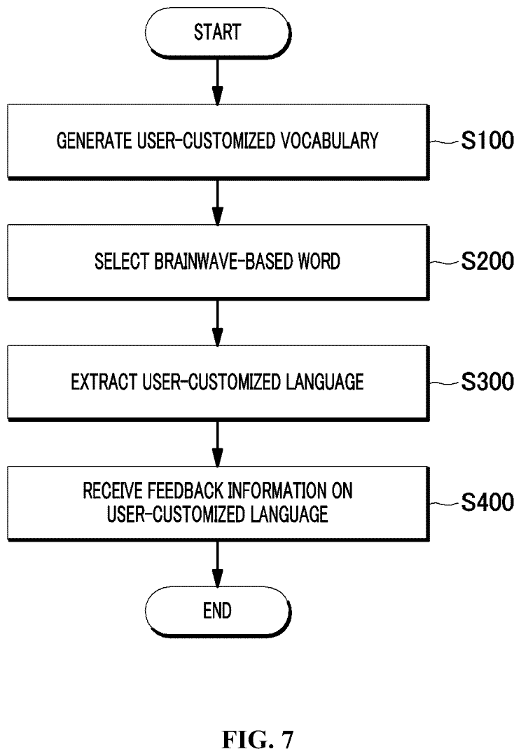

FIG. 7 is a flowchart illustrating a sequence of a user-customized language derivation method according to another embodiment of the present disclosure.

The user-customized language derivation method described below may be performed by the user-customized language derivation device or server described above with reference to FIGS. 1 to 7. Therefore, the content of the embodiment of the present disclosure described above with reference to FIGS. 1 to 7 may be equally applied to the embodiment described below, and redundant descriptions thereof are omitted. Operations described below do not necessarily have to be performed in order, and the order of the operations may be set in various ways, and the operations may be performed almost simultaneously.

Referring to FIG. 7, the user-customized language derivation method includes operation S100 of generating a user-customized vocabulary, operation S200 of deriving a user-intended language, operation S300 of deriving a user-customized language, and operation S400 of receiving feedback information on the user-customized language.

Operation S100 of generating a user-customized vocabulary is an operation of generating the user-customized vocabulary by replacing a user's audio signal with a text signal. In operation S100 of generating the user-customized vocabulary, a length of a time window of a brainwave may be adjusted according to prosodemes, syllables, and phrases to extract voice intent and phonetic intent.

Operation S200 of deriving a user's intended language is an operation of analyzing a user's brainwaves to derive utterance intent and deriving the user's intended language based on the utterance intent and a preset user-customized vocabulary.

Operation S300 of deriving the user-customized language is an operation of deriving the user-customized language by inputting the intended language and the user's situation information to a preset large language model. Here, the user-customized vocabulary may be generated by replacing the user's audio signal with the text signal.

Operation S400 of receiving a user-customized language feedback information may be an operation of transmitting the user-customized language to a terminal connected to communication, receiving feedback information on the user-customized language, and updating a decoder for extracting the intended language according to the feedback information.

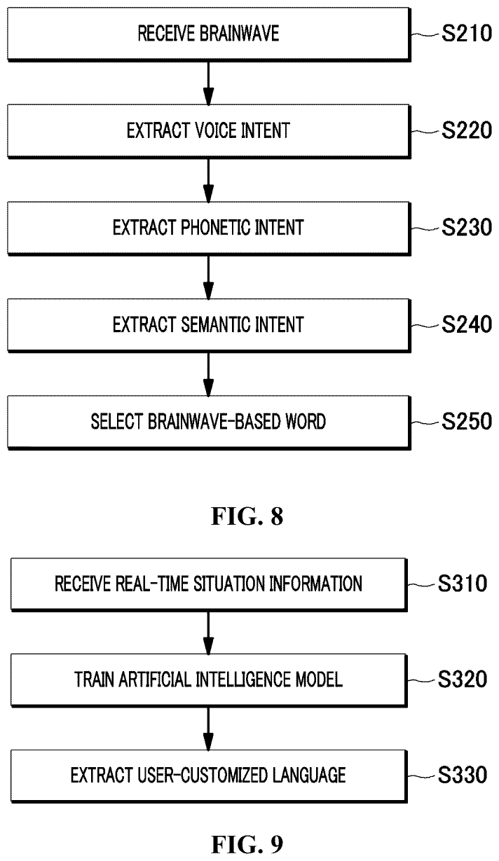

FIGS. 8 and 9 are flowcharts illustrating details of some operations of the user-customized language derivation method according to another embodiment of the present disclosure.

Referring to FIG. 8, operation S200 of selecting an intended language may include operation S210 of receiving brainwaves, operation S220 of extracting voice intent, operation S230 of extracting phonetic intent, operation S240 of extracting semantic intent, and operation S250 of selecting an intended language.

Operation S210 of receiving a brainwave may be an operation of receiving a user's brainwave from a terminal.

Operation S220 of extracting voice intent may be an operation of extracting voice intent that predicts at least one of a position and a size of a formant derived from the motion of vocal cords based on the brainwaves.

Operation S230 of phonetic intent may be an operation of extracting a phonetic intent that predicts at least one of the number of consonants, the number of vowels, and the number of syllables to be uttered based on the voice intent and the brainwaves.

Operation S240 of extracting semantic intent may be an operation of extracting semantic intent by extracting meaning of the language to be uttered in the form of at least one of a category and an embedding vector based on a brainwave.

Operation S240 of extracting a semantic intent may include an operation of predicting the meaning of language in at least one of a form of a category and a form of an embedding vector based on brainwaves, an operation of calculating a word-by-word vector for specific words within the category, and an operation of extracting words according to the semantic intent by comparing spatial similarity between the word-by-word vector and the embedding vector.

Operation S250 of selecting an intended language may be an operation of comparing similarity between word lists according to the semantic intent and the predicted phonology information according to the voice intent and phonetic intent, selecting an intended language based on the similarity and the user-customized vocabulary, and selecting the intended language from among the words corresponding to the user-customized vocabulary by using a preset decoder.

Referring to FIG. 9, operation S300 of deriving a user-customized language may include operation S310 of receiving real-time situation information, operation S320 of training a large language model, and operation S330 of deriving a user-customized language.

Operation S310 of receiving the real-time situation information may be an operation of receiving the user's real-time situation information. Here, the real-time situation information may include information on at least one of a position, clothing, the number of people, an arrangement of objects, a human behavior, a speech style, and a surrounding voice.

Operation S320 of training a large language model may be an operation of training the large language model to output a user-customized language that applies a vocabulary level and a speech style according to a user-customized vocabulary and a user's situation information by considering the user-customized vocabulary and the user's situation information.

Operation S330 of deriving a user-customized language may be an operation of deriving a user-customized language corresponding to an intended language by considering a user's situation information through a large language model.

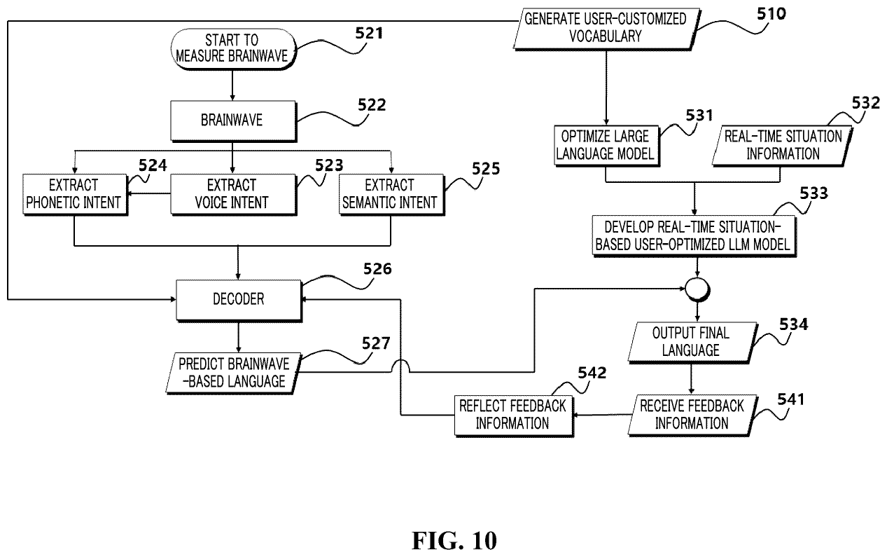

FIG. 10 is a diagram illustrating an example of the user-customized language derivation method according to another embodiment of the present disclosure.

Referring to FIG. 10, a user-customized language derivation device may generate a user-customized vocabulary (510).

The user-customized language derivation device may start brainwave measurement (521) and acquire brainwaves (522).

The user-customized language derivation device performs voice intent extraction (523), phonetic intent extraction (524), and semantic intent extraction (525), and may extract phonetic intent extraction (524) after the voice intent extraction (523). The voice intent extraction (523) and the semantic intent extraction (525) may be performed simultaneously in the same operation, or the semantic intent extraction (525) may be performed first, or the voice intent extraction (523) may be performed first.

The user-customized language derivation device may input the extracted phonetic intent and semantic intent to the decoder (526).

The user-customized language derivation device may predict (527) a brainwave-based language based on the decoder (526).

The user-customized language derivation device may optimize a large language model based on a user-customized vocabulary (531), and receive real-time situation information (532).

The user-customized language derivation device may develop a real-time situation-based user-optimized language model (LLM) based on the optimized large language model and the real-time situation information (533).

The user-customized language derivation device may output a final language based on the developed real-time situation-based user-optimized language model and the predicted brainwave-based language (534).

The user-customized language derivation device may receive feedback information on the final language (541).

The user-customized language derivation device may reflect the feedback information to the decoder (542).

According to the present disclosure, by applying a model that may directly extract and predict a feature point from brainwaves when language is intended, the time consumed for language prediction may be significantly reduced.

Also, according to the present disclosure, a language may be divided into a semantic intent dimension and a phonetic intent dimension, and continuous prediction in the form of a vector may be made in the semantic intent.

Also, according to the present disclosure, by increasing the number of languages that may be generated by combining respective phonetic features from the phonetic intent dimension when constructing a pre-learning model, the amount required for learning may be reduced, and various languages may be implemented.

Also, according to the present disclosure, the language predicted from a user's brainwaves based on artificial intelligence may be replaced with an appropriate expression according to a current situation or context.

Effects of the present disclosure are not limited to the effects described above, and include all effects understood from the descriptions above.

Those skilled in the art to which the present disclosure belongs will understand that the present disclosure may be easily modified into another specific form based on the descriptions given above without changing the technical idea or essential features of the present disclosure. Therefore, the embodiments described above should be understood as illustrative in all respects and not limiting. The scope of the present disclosure is indicated by the claims described below, and all changes or modified forms derived from the meaning, scope of the claims, and their equivalent concepts should be interpreted as being included in the scope of the present disclosure. The scope of the present application is indicated by the claims described below rather than the detailed description above, and all changes or modified forms derived from the meaning, scope of the claims, and their equivalent concepts should be interpreted as being included in the scope of the present application.

What is claimed is:

1. A user-customized language derivation method based on brainwaves performed by a user-customized language derivation device based on brainwaves, the user-customized language derivation method comprising:
deriving utterance intent by analyzing brainwaves of a user, and deriving an intended language of the user based on the utterance intent and a preset user-customized vocabulary; and
deriving a user-customized language by inputting the intended language and situation information of the user to a preset large language model,
wherein the large language model is pre-trained to output the user-customized language by considering the user-customized vocabulary and the situation information of the user.

2. The user-customized language derivation method of claim 1, wherein
the user-customized vocabulary is generated by replacing an audio signal of the user with a text signal.

3. The user-customized language derivation method of claim 1, wherein the deriving of the utterance intent and the deriving of the intended language comprises:
deriving voice intent, phonetic intent, and semantic intent; and
selecting an intended language having similarity, which is greater than or equal to a preset value, with the utterance intent among words included in the user-customized vocabulary.

4. The user-customized language derivation method of claim 3, wherein
the utterance intent includes the phonetic intent, the voice intent, and the semantic intent,
the phonetic intent is generated based on at least one of a position and a size of a formant expressed from a motion of a vocal cord extracted from the brainwaves,
the voice intent is generated based on at least one of the phonetic intent and numbers of consonants, vowels, and syllables to be uttered extracted from the brainwaves, and
the semantic intent is generated in a form of at least one of a category and an embedding vector for meaning of a language to be uttered from the brainwaves.

5. The user-customized language derivation method of claim 4, wherein the deriving of the voice intent, the phonetic intent, and the semantic intent comprises:
predicting the meaning of the language as at least one of a form of the category and a form of the embedding vector, based on the brainwaves;
generating word-by-word vectors for specific words in the category; and
extracting a word list according to the semantic intent by comparing spatial similarities between a word-by-word vector and the embedding vector.

6. The user-customized language derivation method of claim 3, wherein the selecting of the intended language comprises:
comparing similarities between word lists according to the semantic intent and phonetic information predicted according to the voice intent by using a preset decoder by considering the user-customized vocabulary; and
selecting the intended language based on the similarity, and selecting the intended language from among words corresponding to the user-customized vocabulary by using the preset decoder.

7. The user-customized language derivation method of claim 1, wherein
vocal intent and phonetic intent of the utterance intent are extracted by adjusting a length of a time window of the brainwaves according to prosodemes, syllables, and phrases.

8. The user-customized language derivation method of claim 1, wherein the deriving of the user-customized language comprises:
receiving real-time situation information of the user;
training the large language model to output the user-customized language to which the user-customized vocabulary and a vocabulary level and a speech style according to the situation information of the user are applied, by considering the user-customized vocabulary and the situation information of the user; and
extracting the user-customized language corresponding to the intended language by considering the situation information of the user through the large language model.

9. The user-customized language derivation method of claim 1, further comprising:
transmitting the user-customized language to a terminal communicably connected to the user-customized language derivation device, receiving feedback information on the user-customized language, and updating a decoder for extracting a brainwave-based language according to the feedback information.

10. A user-customized language derivation device based on a brainwave, the user-customized language derivation device comprising:
a communication module communicably connected to a terminal;
a processor; and
a memory electrically connected to the processor and storing at least one code configured to be executed by the processor,
wherein, when the memory is operated by the processor, the processor derives utterance intent by analyzing brainwaves of a user, derives an intended language of the user based on the utterance intent and a preset user-customized vocabulary, and derives a user-customized language by inputting the intended language and situation information of the user to a preset large language model, and
the large language model is pre-trained to output the user-customized language by considering the user-customized vocabulary and the situation information of the user.

11. The user-customized language derivation device of claim 10, wherein
the user-customized vocabulary is generated by replacing an audio signal of the user with a text signal.

12. The user-customized language derivation device of claim 10, wherein
the memory stores code that causes the processor to derive voice intent, phonetic intent, and semantic intent, and select an intended language having similarity, which is greater than or equal to a preset value, with the utterance intent among words included in the user-customized vocabulary.

13. The user-customized language derivation device of claim 12, wherein
the utterance intent includes the phonetic intent, the voice intent, and the semantic intent,
the phonetic intent is generated based on at least one of a position and a size of a formant expressed from a motion of a vocal cord extracted from the brainwaves,
the voice intent is generated based on at least one of the phonetic intent and numbers of consonants, vowels, and syllables to be uttered extracted from the brainwaves, and
the semantic intent is generated in a form of at least one of a category and an embedding vector for meaning of a language to be uttered from the brainwaves.

14. The user-customized language derivation device of claim 13, wherein
the memory stores code that causes the processor to predict the meaning of the language as at least one of a form of the category and a form of the embedding vector, based on the brainwaves, generate word-by-word vectors for specific words in the category, and extract a word list according to the semantic intent by comparing spatial similarities between a word-by-word vector and the embedding vector.

15. The user-customized language derivation device of claim 12, wherein
the memory stores code that causes the processor to compare similarities between word lists according to the semantic intent and phonetic information predicted according to the voice intent by using a preset decoder by considering the user-customized vocabulary, and select the intended language based on the similarity, and select the intended language from among words corresponding to the user-customized vocabulary by using the preset decoder.

16. The user-customized language derivation device of claim 10, wherein
vocal intent and phonetic intent of the utterance intent are extracted by adjusting a length of a time window of the brainwaves according to prosodemes, syllables, and phrases.

17. The user-customized language derivation device of claim 10, wherein
the memory stores code that causes the processor to receive real-time situation information of the user, train the large language model to output the user-customized language to which the user-customized vocabulary and a vocabulary level and a speech style according to the situation information of the user are applied, by considering the user-customized vocabulary and the situation information of the user, and extract the user-customized language corresponding to the intended language by considering the situation information of the user through the large language model.

18. The user-customized language derivation device of claim 10, wherein
the memory stores code that causes the processor to transmit the user-customized language to a terminal communicably connected to the user-customized language derivation device, receive feedback information on the user-customized language, and update a decoder for extracting a brainwave-based language according to the feedback information.
